(19) United States
(12) Patent Application Publication
(10) Pub. No.: US 2006/0236817 A1
(43) Pub. Date: Oct. 26, 2006

(54) Power tool for and method of moving elements relative to an object

(76) Inventor: Jason Junkers, Park Ridge, NJ (US)

Correspondence Address: STRIKER, STRIKER & STENBY, 103 EAST NECK ROAD, HUNTINGTON, NY, 11743, US

(21) Appl. No.: 11/113,743

(22) Filed: Apr. 25, 2005

(51) Int. Cl. B25B 21/00; B25B 17/00

(52) U.S. Cl. 81/57.22; 81/57.14; 81/57.3

(57) ABSTRACT

For moving an element relative to an object a plurality of screw members having polygonal heads are screwed in threaded openings on the element and arranged around an axis so as to be circumferentially spaced from one another, an action drive and a reaction drive arranged coaxially to the axis and with one another and turnable in opposite directions apply opposite turning forces to the screw members on an outer circumference and on an inner circumference correspondingly so as to turn the screw members in one and the same direction to thereby move the element in an axial direction, and a plurality of transmitting members engage by first engaging formations both with the action drive and the reaction drive turnable in the opposite directions so as to be turned in one and the same direction and engage by second engaging formations with the polygonal heads of the screw members for transmitting the turning of the transmitting members in one and the same direction into turning of the screw members in one and the same direction.

### BACKGROUND OF THE INVENTION

The present invention relates to power tool for and methods of moving elements relative to an object, for example for moving a nut which is screwed on a bolt, a head of a bolt, etc.

Power tools of the above mentioned general type are known in the art. One of such power tools is disclosed in my U.S. Pat. No. 5,934,853. In this patent the screws are turned simultaneously by applying a turning force to an inner circumference of the gears by a drive. Since the tool has only one drive for applying the turning force to the inner circumference, a side load, a torsion, and a bending force can act on a ring-shaped member which turns the screws.

In my U.S. Pat. No. 6,058,810 an action drive and a reaction drive apply turning forces to the screws both on an inner circumference and on an outer circumference of the screws by interengagement of the inner gear ring and the outer gear ring of the drives with the gears provided on the screw members. With this construction the above mentioned disadvantages are eliminated; however, it is believed that this construction can be further improved.

### SUMMARY OF THE INVENTION

Accordingly, it is an object of the present invention to provide a power tool for and a method of moving an element relative to an object, which are further improvements of the existing power tools and methods.

In keeping with these objects and with others which will become apparent hereinafter, one feature of the present invention resides, briefly stated, in a power tool for moving an element in an axial direction relative to an object, comprising a plurality of screw members having polygonal heads, said screw members being screwable in threaded openings on the element and arranged around an axis so as to be circumferentially spaced from one another; drive means including an action drive and a reaction drive arranged coaxially to said axis and with one another and turnable in opposite directions so as to apply opposite turning forces to said screw members on an outer circumference and on an inner circumference correspondingly, so as to turn said screw members in one and the same direction to thereby move the element in an axial direction; and means for transmitting the turning of said action drive and said reaction drive in the opposite directions into the turning of said screw members in one and the same direction, said transmitting means including a plurality of transmitting members provided with first engaging means for engaging both with said action drive and said reaction drive turnable in the opposite directions so as to be turned in one and the same direction and with second engaging means engageable with said polygonal heads of said screw members for transmitting the turning of said transmitting members in one and the same direction into turning of said screw members in one and the same direction.

Another feature of the present invention resides, briefly stated, in a method of moving an element in an axial direction relative to an object by a power tool, comprising the steps of screwing a plurality of screw members having polygonal heads into threaded openings of the element so that the screw members are arranged around an axis and circumferentially spaced from one another; applying to the screw members by drive means having action and reaction drives opposite turning forces on an outer circumference and on an inner circumference of the screw members correspondingly so as to turn the screw members in one and the same direction and thereby to move the element in an axial direction; and transmitting the turning of the action drive and the reaction drive in the opposite directions into the turning of the screw members in one and the same direction by transmitting means including a plurality of transmitting members provided with first engaging means for engaging both with said action drive and said reaction drive turnable in the opposite directions so as to be turned in one and the same direction and with second engaging means engageable with said polygonal heads of said screw members for transmitting the turning of said transmitting members in one and the same direction into turning of said screw members in one and the same direction.

When the tool is designed and the method is performed in accordance with the present invention, efficient and predetermined movement of the element relative to the object is performed.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a tool for moving an element relative to an object in accordance with one embodiment of the present invention; and

FIG. 2 is a view showing a tool for moving an element relative to an object in accordance with another embodiment of the present invention.

### DESCRIPTION OF THE PREFERRED EMBODIMENTS

A power tool in accordance with the present invention which operates in accordance with the inventive method has a housing which is identified as a whole with reference numeral 1. A not shown main drive unit is accommodated in the housing 1 and can be formed for example as a fluid-operated cylinder-piston unit provided for example with a turning element for producing a turning action.

The power tool has an action drive and a reaction drive. One of said drives includes a central shaft 2 which is connected with the turning element of the main drive unit. At the opposite end, the shaft 2 is connected with a central inner gear 3 having outer teeth, splines and the like. The other drive includes an annular member 4 which is connected with the housing and provided with an outer gear 5 having inner teeth, splines, and the like. The shaft 2 extends centrally through the annular member 4 to permit independent rotation of the shaft 2 and the annular member 4 relative to one another. The drives 2, 3 and 4, 5 are coaxial with one another and with a central axis A.

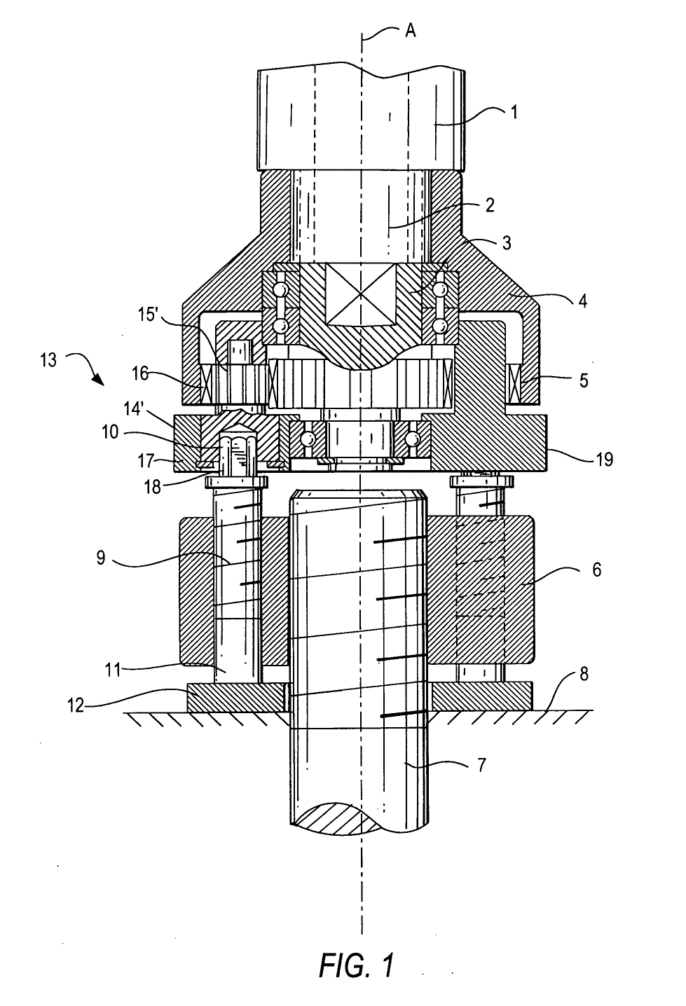

The power tool in accordance with the present invention is used for providing an axial movement of an element relative to an object. In the shown embodiment of FIG. 1, the element is represented by a nut 6 which is screwed on a bolt 7 extending through an object 8, for example a flange and the like. A plurality of screws 9 provided with polygonal (hexagonal) heads 10 are screwed in threaded openings of the nut 6 and are spaced from one another in a circumferential direction around the axis A. Another opposite end 11 of each screw 9 abuts against a washer 12 located between the screws 9 and the object 8.

The drive 2, 3 is configured to turn the screws 9 from inside on an inner circumference, while the drive 4, 5, is configured to turn the screws 9 from outside on the outer circumference. For this purpose, the tool in accordance with the present invention is provided with transmission means which are identified as a whole with reference numeral 13. The transmission means include a plurality of transmitting members 14 which are spaced from one another in a circumferential direction. Each of the transmitting members 14 has a first portion 15 provided with first engaging means 16. The first engaging means are formed for example as teeth configured to be engaged by the outer teeth of the central inner gear 3 from inside on an inner circumference, and also by the inner teeth of the outer gear 5 from outside on the outer circumference. Each of the transmitting members 14 has another portion 17 which is spaced from the first portion 15 axially and provided with second engaging means 18. The second engaging means are formed for example as a polygonal (hexagonal) receptacle for receiving the polygonal head 10 of the corresponding screw member 9. Finally, the power tool has a carrier 19 for holding some parts of the tool.

The power tool in accordance with the present invention operates in the following manner:

When the power tool is activated, the main drive unit causes turning of the shaft 2 in one direction and therefore also turns the central gear 3 of the first drive 2, 3. As a result of a reaction force, the housing 1 of the tool turns in an opposite direction and thereby turns the annular member 4 and therefore the outer gear 5 in the opposite directions. As a result, the first portions 15 of the transmitting members 14 and also the second portions 17 of the transmitting members are turned in one and the same direction under the action of the turning forces applied radially outerwardly and radially. inwardly on outer and inner circumferences to each transmitting member 14. The heads 17 of the screw members 9 and therefore the screw members 9 as a whole are turned in one and the same direction and displace the element (the nut) 6 axially to tighten or loosen the bolt 7 in the object 8, depending on the direction of rotation of the screw members 9.

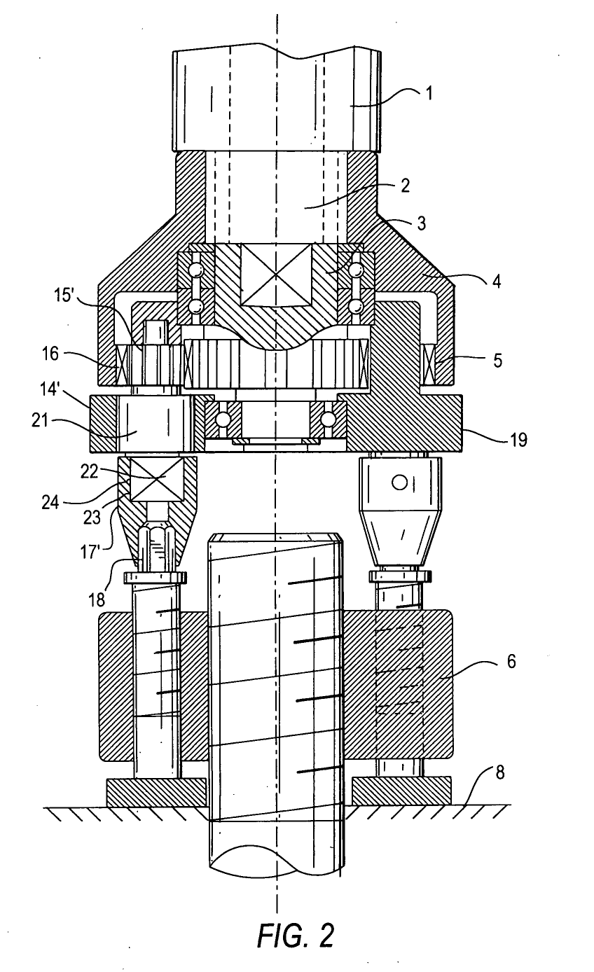

In the embodiment shown in FIG. 1 the transmitting members 14 are formed as one-piece integral members provided with two portions 15 and 17 as well as with first engaging means 16 and with the second engaging means 18. In the embodiment shown in FIG. 2 the transmitting members are formed in a different manner.

In the embodiment shown in FIG. 2 each transmitting member 14′ includes again the first portion 15′ provided with first engaging means 16 and the second portion 17′ provided with the second engaging means 18. However, the first portion 15′ and the second portion 17′ are formed as two separate elements which are connected with one another so that they can not rotate relative to one another.

For this purpose in the power tool in accordance with the embodiment of FIG. 2 the first portion 15′ of each transmitting member is provided with an additional portion 21 which is housed in a corresponding opening of the carrier 19 and with an additional, preferably non-round projection 22. In turn, the second portion 17′ of each transmitting member is provided with a non-round opening 23 in which the non-round projection 22 can engage, with a connecting element, for example a pin 24, providing a connection therebetween.

The operation of the power tool in accordance with the embodiment of FIG. 2 is substantially the same.

It will be understood that each of the elements described above, or two or more together, may also find a useful application in other types of constructions and methods differing from the types described above.

While the invention has been illustrated and described as embodied in power tools for and method of moving elements relative to an object, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A power tool for moving an element relative to an object, comprising a plurality of screw members having polygonal heads, said screw members being screwable in threaded openings on the element and arranged around an axis so as to be circumferentially spaced from one another; drive means including an action drive and a reaction drive arranged coaxially to said axis and with one another and turnable in opposite directions so as to apply opposite turning forces to said screw members on an outer circumference and on an inner circumference correspondingly, so as to turn said screw members in one and the same direction to thereby move the element in an axial direction; and means for transmitting the turning of said action drive and said reaction drive in the opposite directions into the turning of said screw members in one and the same direction, said transmitting means including a plurality transmitting members provided with first engaging means for engaging both with said action drive and said reaction drive turnable in the opposite directions so as to be turned in one and the same direction and with second engaging means engageable with said polygonal heads of said screw members for transmitting the turning of said transmitting members in one and the same direction into turning of said screw members in one and the same direction.

2. A power tool as defined in claim 1, wherein each of said transmitting members has a first portion provided with said first engaging means for engaging with said action drive and said reaction drive, and a second portion provided with said second engaging means for engaging with said polygonal heads of said screw members, said first portion and said second portion being axially spaced from one another.

3. A power tool as defined in claim 2, wherein said first portion and said second portion of each of said transmitting members together form a one-piece integral transmitting member.

4. A power tool as defined in claim 2, wherein said first and said second portion of each of said transmitting members are formed as separate portions and connected with one another for joint rotation therewith; and further comprising means for connecting said first portion and said second portion with one another.

5. A method of moving an element in an axial direction relative to an object by a power tool, comprising the steps of screwing a plurality of screw members having polygonal heads into threaded openings of the element so that the screw members are arranged around an axis and circumferentially spaced from one another; applying to the screw members by drive means having action and reaction drives opposite turning forces on an outer circumference and on an inner circumference of the screw members correspondingly so as to turn the screw members in one and the same direction and thereby to move the element in an axial direction; and transmitting the turning of the action drive and the reaction drive in the opposite directions into the turning of the screw members in one and the same direction by transmitting means including a plurality of transmitting members provided with first engaging means for engaging both with said action drive and said reaction drive turnable in the opposite directions so as to be turned in one and the same direction and with second engaging means engageable with said polygonal heads of said screw members for transmitting the turning of said transmitting members in one and the same direction into turning of said screw members in one and the same direction.
